(19) United States
(12) Patent Application Publication
(10) Pub. No.: US 2024/0394984 A1
(43) Pub. Date: Nov. 28, 2024

(54) SYNTHESIS OF AUGMENTED REALITY CONTENT WITH GRAPHS

(71) Applicant: International Business Machines Corporation, Armonk, NY (US)

(72) Inventors: Jeremy R. Fox, Georgetown, TX (US); Aaron K. Baughman, Cary, NC (US); Zachary A. Silverstein, Georgetown, TX (US); Sarbajit K. Rakshit, Kolkata (IN); Tushar Agrawal, West Fargo, ND (US)

(21) Appl. No.: 18/323,526

(22) Filed: May 25, 2023

(51) Int. Cl. G06T 19/00; G06V 10/74

(52) U.S. Cl. CPC G06T 19/006; G06V 10/761

(57) ABSTRACT

A computer-implemented method for determining context granularity is provided. The computer-implemented method includes determining an activity for a user and a distance between the user and a location of the activity, ascertaining a contextual information granularity level for displaying contextual information relevant to the activity in an augmented reality (AR) interface in accordance with the distance, displaying the contextual information corresponding to the contextual information granularity level in the AR interface, updating the contextual information granularity level as the distance changes to obtain a new contextual information granularity level and displaying the contextual information corresponding to the new contextual information granularity level in the AR interface.

### BACKGROUND

The present invention generally relates to augmented reality, and more specifically, to a method and system for the synthesis of augmented reality content with graphs.

Augmented reality (AR) is an interactive experience that combines real-world and computer-generated content. The content can span multiple sensory modalities, including visual, auditory, haptic, somatosensory and olfactory.

In some cases, AR can be defined as a system that incorporates three basic features: a combination of real and virtual worlds, real-time interaction and accurate three-dimensional (3D) registration of virtual and real objects. Overlaid sensory information can be constructive (i.e., additive to the natural environment) or destructive (i.e., masking of the natural environment). This experience is seamlessly interwoven with the physical world such that it is perceived as an immersive aspect of the real environment. In this way, augmented reality alters one's ongoing perception of a real-world environment.

### SUMMARY

Embodiments of the present invention are directed to a computer-implemented method for determining context granularity. The computer-implemented method includes determining an activity for a user and a distance between the user and a location of the activity, ascertaining a contextual information granularity level for displaying contextual information relevant to the activity in an augmented reality (AR) interface in accordance with the distance, displaying the contextual information corresponding to the contextual information granularity level in the AR interface, updating the contextual information granularity level as the distance changes to obtain a new contextual information granularity level and displaying the contextual information corresponding to the new contextual information granularity level in the AR interface.

As a result of an execution of the computer-implemented method, a user approaching a location of an activity is provided with a display of information in an augmented reality (AR) interface and interactive options. The information is relevant to the activity and the interactive options are relevant to the activity for interaction with by the user. As the distance between the user and the location of the activity changes, the display of the information and the display of the interactive options change.

In accordance with additional or alternative embodiments of the invention, the AR interface is supported by an article that is wearable by the user.

In accordance with additional or alternative embodiments of the invention, the ascertaining is executed by a machine-learning algorithm and is based on real-time updateable historic data of the user, the activity and surroundings.

In accordance with additional or alternative embodiments of the invention, the contextual information includes information relevant to the activity and interactive options relevant to the activity for interaction with by the user.

In accordance with additional or alternative embodiments of the invention, the displaying of the contextual information corresponding to the contextual information granularity level includes displaying a first level of the information and displaying a first level of the interactive options and the displaying of the contextual information corresponding to the new contextual information granularity level includes displaying a second level of the information, which differs from the first level, and displaying a second level of the interactive options, which differs from the first level.

In accordance with additional or alternative embodiments of the invention, the displaying of the contextual information includes overlaying the contextual information on a real-world display in the AR interface and the computer-implemented method further includes displaying additional information of surroundings of the user and the location in the AR interface.

In accordance with additional or alternative embodiments of the invention, each instance of the updating is discrete.

Embodiments of the invention further provide computer program products and computer systems having substantially the same features and technical benefits as the above-described computer-implemented methods.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 is a schematic diagram of a computing environment for executing a computer-implemented method for selectively capturing traffic in a service mesh to simulate and address an issue with a service invoke chain in accordance with one or more embodiments of the present invention;

FIG. 2 is a block diagram of components of a machine learning training and inference system according to one or more embodiments of the present invention;

FIG. 3 is a schematic diagram illustrating is a flow diagram illustrating how a graph convolutional network (GCN) can be generated in accordance with one or more embodiments of the present invention;

FIG. 4 is a graphical flow diagram illustrating how a GCN is used to generate an output in accordance with one or more embodiments of the present invention;

FIG. 5 is a flow diagram illustrating a computer-implemented method for determining context granularity in accordance with one or more embodiments of the present invention; and

FIG. 6 is a diagrammatic illustration of an execution of the computer-implemented method of FIG. 5 in accordance with one or more embodiments of the present invention.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two or three digit reference numbers. With minor exceptions, the leftmost digit(s) of each reference number correspond to the figure in which its element is first illustrated.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

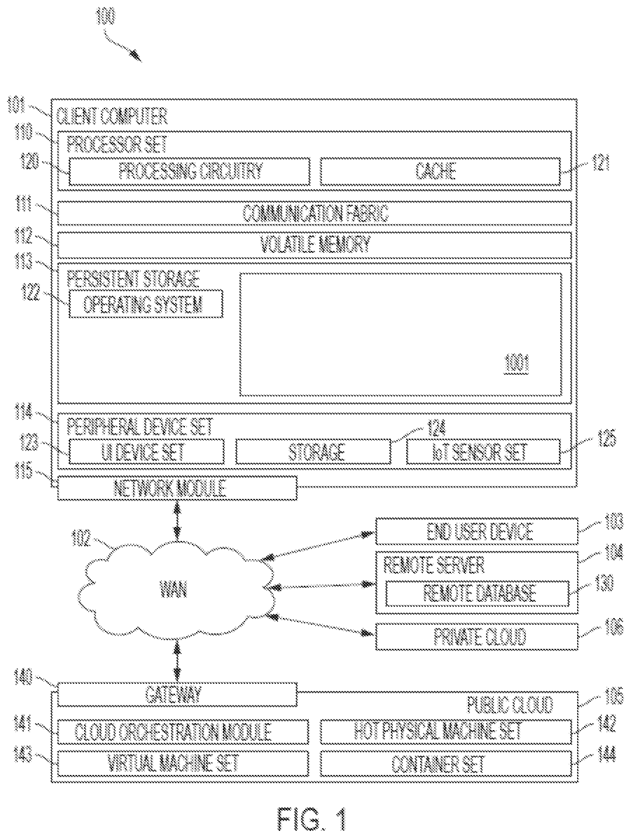

With reference to FIG. 1, a computer or computing device 100 that implements a computer-implemented method for selectively capturing traffic in a service mesh to simulate and address an issue with a service invoke chain in accordance with one or more embodiments of the present invention is provided. The computer or computing device 100 of FIG. 1 contains an example of an environment for the execution of at least some of the computer code involved in performing the inventive methods, such as the block 1001 of the computer-implemented method for selectively capturing traffic in a service mesh to simulate and address an issue with a service invoke chain. In addition to the computer-implemented method for selectively capturing traffic in a service mesh to simulate and address an issue with a service invoke chain of block 1001, the computer or computing device 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and the computer-implemented method of block 1001, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

The computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of the computer-implemented method, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

The processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In the computer-implemented method, at least some of the instructions for performing the inventive methods may be stored in the block 1001 of the computer-implemented method in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in the block 1001 of the computer-implemented method typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Turning now to an overview of technologies that are more specifically relevant to aspects of the invention, in any work setting, entertainment activity or learning module, people interact and engage with various types of systems. Robotics and machinery, such as computing systems, are a critical component of such engagement. The use of AR through those computing systems helps guide users within their environment to optimally arrive towards a goal. The objective can be established by a user, employer, venue or a surrounding crowd. The AR provides the user with appropriate guidance, activity specific information and security and safety guidance so that users can effectively and safely perform certain activities.

While a user performs a job or takes part in an activity, the user can be guided with AR towards a goal. However, the guidance trajectory provided by the AR might be too broad for one person or too narrow for another. Thus, the technology can quickly become frustrating and cumbersome.

Turning now to an overview of the aspects of the invention, one or more embodiments of the invention address shortcomings of the above-described approach by providing for a computer-implemented method for determining context granularity that includes determining an activity for a user and a distance between the user and a location of the activity, ascertaining a contextual information granularity level for displaying contextual information relevant to the activity in an augmented reality (AR) interface in accordance with the distance, displaying the contextual information corresponding to the contextual information granularity level in the AR interface, updating the contextual information granularity level as the distance changes to obtain a new contextual information granularity level and displaying the contextual information corresponding to the new contextual information granularity level in the AR interface.

The above-described aspects of the invention address the shortcomings of known approaches by providing for an optimization of an assistance trajectory by synthesizing or removing superfluous AR steps. A dynamic system uses a convolutional network to determine a relevant context granularity to display to a user as the user approaches an interaction point in AR. The dynamic system can use historic data that describes what the user normally looks at to improve the determination of the relevant context granularity.

In other words, based on contextual analysis of any activity, the proposed dynamic system will use historic data to identify a level of information completeness in an AR environment so that a user's experience in the AR environment can be improved. The proposed dynamic system will allow for creation of augmented and physical nodes within both an occluded and clear directed acyclic graph, the agglomeration of nodes given physical and digital adjacency matrices that are not occluded, generative model creation of a new node based on occluded adjacency nodes and average features of a neighborhood of nodes, removal of nodes with agglomeration through clustering and generative model creation of both digital and physical styling based on node analysis.

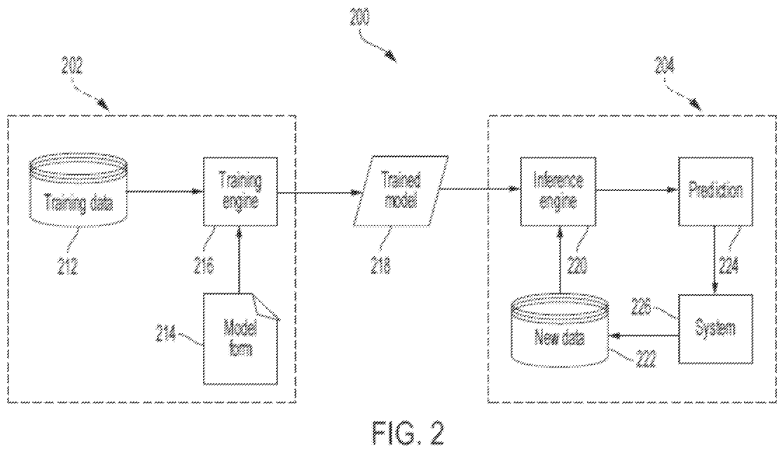

Turning now to a more detailed description of aspects of the present invention, FIG. 2 depicts a block diagram of components of a machine learning training and inference system 200. The machine learning training and inference system 200, in accordance with one or more embodiments of the invention, can utilize machine learning techniques to perform tasks, such as.

Embodiments of the invention utilize AI, which includes a variety of so-called machine learning technologies. The phrase “machine learning” broadly describes a function of electronic systems that learn from data. A machine learning system, engine, or module can include a trainable machine learning algorithm that can be trained, such as in an external cloud environment, to learn functional relationships between inputs and outputs, and the resulting model (sometimes referred to as a “trained neural network,” “trained model,” and/or “trained machine learning model”) can be used for managing information during a web conference, for example. In one or more embodiments of the invention, machine learning functionality can be implemented using an artificial neural network (ANN) having the capability to be trained to perform a function. In machine learning and cognitive science, ANNs are a family of statistical learning models inspired by the biological neural networks of animals, and in particular the brain. ANNs can be used to estimate or approximate systems and functions that depend on a large number of inputs. Convolutional neural networks (CNN) are a class of deep, feed-forward ANNs that are particularly useful at tasks such as, but not limited to analyzing visual imagery and natural language processing (NLP). Recurrent neural networks (RNN) are another class of deep, feed-forward ANNs and are particularly useful at tasks such as, but not limited to, unsegmented connected handwriting recognition and speech recognition. Other types of neural networks are also known and can be used in accordance with one or more embodiments of the invention described herein.

ANNs can be embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making ANNs adaptive to inputs and capable of learning. For example, an ANN for handwriting recognition is defined by a set of input neurons that can be activated by the pixels of an input image. After being weighted and transformed by a function determined by the network's designer, the activation of these input neurons are then passed to other downstream neurons, which are often referred to as “hidden” neurons. This process is repeated until an output neuron is activated. The activated output neuron determines which character was input. It should be appreciated that these same techniques can be applied in the case of localizing a target object referred by a compositional expression from an image set with similar visual elements as described herein.

A graph convolutional network (GCN) can also be provided. A graph convolutional network (GCN) is a type of neural network that is designed to operate on graph-structured data, such as social networks, molecular structures and geographical data. GCNs are like CNNs, which are designed to operate on grid-structured data, such as images. Often, GCNs are built on the idea of convolutional filters, which are used to extract local features from data. In a GCN, the convolutional filters are applied to the edges of a graph, rather than the grid of an image. This allows the GCN to capture the structure of the data, rather than just the local features. GCNs have been used for a variety of tasks, including node classification, link prediction, and graph classification. As described further below, an ability to utilize GCNs within an AR environment is derived.

The machine learning training and inference system 200 performs training 202 and inference 204. During training 202, a training engine 216 trains a model (e.g., the trained model 218) to perform a task. Inference 204 is the process of implementing the trained model 218 to perform the task in the context of a larger system (e.g., a system 226).

The training 202 begins with training data 212, which can be structured or unstructured data. The training engine 216 receives the training data 212 and a model form 214. The model form 214 represents a base model that is untrained. The model form 214 can have preset weights and biases, which can be adjusted during training. It should be appreciated that the model form 214 can be selected from many different model forms depending on the task to be performed. For example, where the training 202 is to train a model to perform image classification, the model form 214 can be a model form of a CNN (convolutional neural network). The training 202 can be supervised learning, semi-supervised learning, unsupervised learning, reinforcement learning, and/or the like, including combinations and/or multiples thereof. For example, supervised learning can be used to train a machine learning model to classify an object of interest in an image. To do this, the training data 212 includes labeled images, including images of the object of interest with associated labels (ground truth) and other images that do not include the object of interest with associated labels. In this example, the training engine 216 takes as input a training image from the training data 212, makes a prediction for classifying the image, and compares the prediction to the known label. The training engine 216 then adjusts weights and/or biases of the model based on results of the comparison, such as by using backpropagation. The training 202 can be performed multiple times (referred to as “epochs”) until a suitable model is trained (e.g., the trained model 218).

Once trained, the trained model 218 can be used to perform inference 204 to perform a task. The inference engine 220 applies the trained model 218 to new data 222 (e.g., real-world, non-training data). For example, if the trained model 218 is trained to classify images of a particular object, such as a chair, the new data 222 can be an image of a chair that was not part of the training data 212. In this way, the new data 222 represents data to which the model 218 has not been exposed. The inference engine 220 makes a prediction 224 (e.g., a classification of an object in an image of the new data 222) and passes the prediction 224 to the system 226. The system 226 can, based on the prediction 224, taken an action, perform an operation, perform an analysis, and/or the like, including combinations and/or multiples thereof. In some embodiments of the invention, the system 226 can add to and/or modify the new data 222 based on the prediction 224.

In accordance with one or more embodiments of the invention, the predictions 224 generated by the inference engine 220 are periodically monitored and verified to ensure that the inference engine 220 is operating as expected. Based on the verification, additional training 202 can occur using the trained model 218 as the starting point. The additional training 202 can include all or a subset of the original training data 212 and/or new training data 212. In accordance with one or more embodiments of the invention, the training 202 includes updating the trained model 218 to account for changes in expected input data.

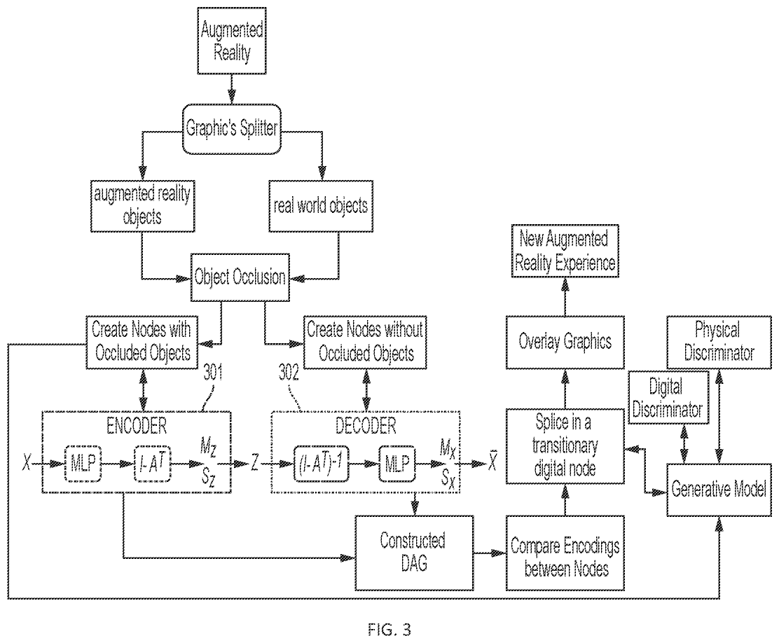

With reference to FIG. 3, as digital and physical elements might not be cohesive, a generative approach with relational directed acyclic graphs (DAGs) can produce intermediary nodes to create transitionary AR elements. The transitionary AR elements smooth out interactions between digital and physical elements. First, the AR experience is split into physical and digital streams. CNNs can be applied to each stream independently to identify objects that are physical or digital. Each of the recognized objects becomes a node and is described by their CNN attributes and user interaction metrics. A GNN learns an adjacency matrix for two types of DAGs. The first DAG 301 encompasses all objects that are occluded by a digital or physical element. The adjacency matrix is used as an input into a generative model as context to help boost the probability that a transitionary AR node will be added around an occlusion. The second DAG 302 represents a DAG encompassing non-occluded objects. The adjacency matrix accordingly creates edges between visible nodes. Each of the nodes that are connected are measured in terms of GCN node merging. The less similar relationships for nodes that are disjointed are sent to the generative model to produce a transitionary AR node. The generative model accepts as input the occluded adjacency matrix, the two-node feature vectors and current graphics. Next, both physical and digital transitionary nodes are created. The node with the highest similarity to the edge nodes is spliced into the AR interface. Alternatively, if a node is agglomerated together with another highly similar node, then the node that has the fewest agglomeration activities is removed from the AR interface.

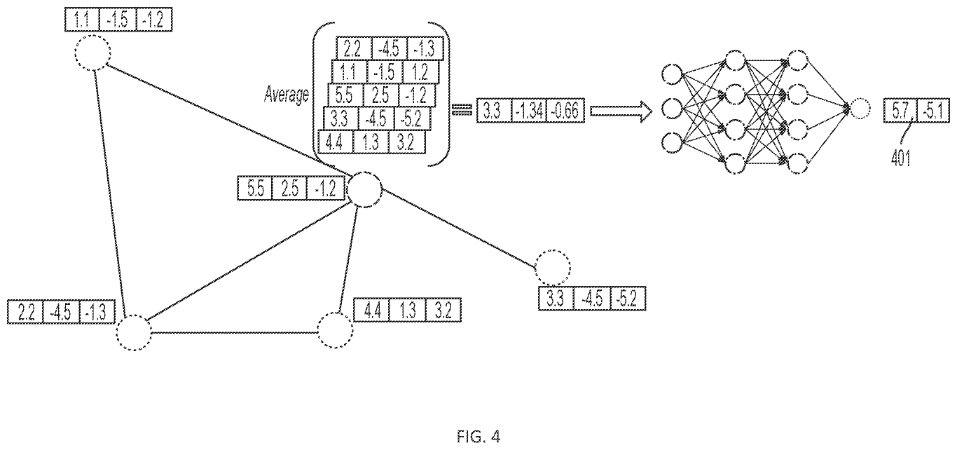

With continued reference to FIG. 3 and with additional reference to FIG. 4. each of the nodes learned from the digital and physical are linked with a DAG. Thus, if the central node in FIG. 4 is considered, neighboring nodes can be convolved and the convolved vectors can be passed to a GCN. An output 401 of the GCN describes a degree to which nodes are similar and informs the machine-learning algorithm as to whether another model-generated AR graphic should be inserted into the AR interface.

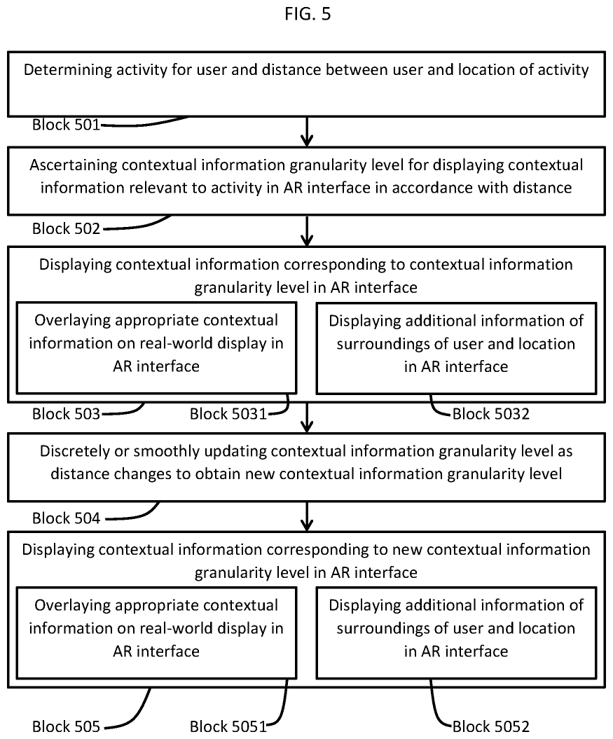

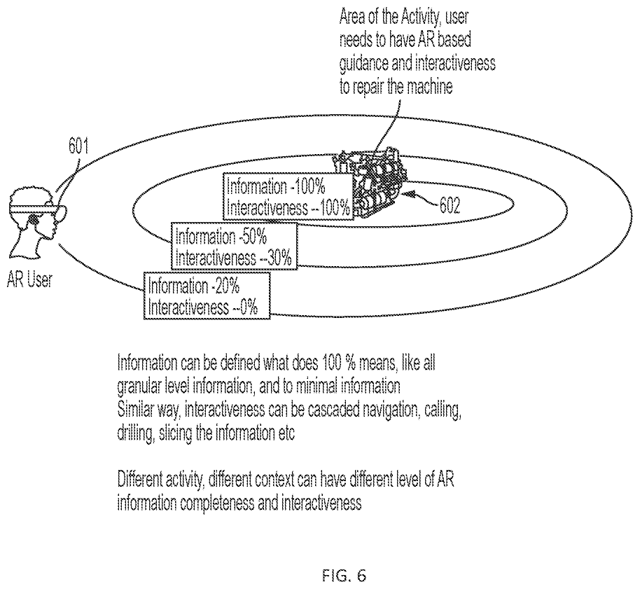

With reference to FIG. 5, a computer-implemented method 500 is provided for determining context granularity. As shown in FIG. 5, the computer-implemented method 500 includes determining an activity for a user and a distance between the user and a location of the activity (block 501), ascertaining a contextual information granularity level for displaying contextual information relevant to the activity in an AR interface in accordance with the distance (block 502), displaying the contextual information corresponding to the contextual information granularity level in the AR interface (block 503), updating the contextual information granularity level as the distance changes to obtain a new contextual information granularity level (block 504) and displaying the contextual information corresponding to the new contextual information granularity level in the AR interface (block 505). The AR interface can be supported by an article, such as AR goggles (see FIG. 6), which is wearable by the user.

The ascertaining of the contextual information granularity level can be executed by a machine-learning algorithm along the lines described above and can be based on real-time updateable historic data of the user, the activity and surroundings of the user and the location of the activity. For example, the machine-learning algorithm can take into account information about what items the user normally looks at through AR goggles, how long the user looks at those items and how much the user interacts with the items. The machine-learning algorithm can also consider information about the activity, whether the user or any other persons have ever done the activity before, when and for how long and what external items might be needed for the activity (i.e., a handheld computing device for a service technician). In addition, the machine-learning algorithm can consider externalities such as real-world items between the user and the location of the activity. In such cases, the machine-learning algorithm might limit what is displayed to the user about the activity in favor of a warning not to walk into the real-world items.

The contextual information can include information that is relevant to the activity as well as interactive options that are relevant to the activity and that could be interacted with by the user. The information can include a broad description of the activity, a narrow description of the activity and a description of additional information about the relationship between the activity and externalities. The interactive options can be a set of basic interactive options, such as lighting or highlighting the location of the activity, a set of intermediate interactive options, such as menus for scrolling through various files associated with the activity, and a set of advanced interactive options, such as video clips of the activity being performed.

The displaying of the contextual information corresponding to the contextual information granularity level of block 503 can include overlaying the appropriate contextual information on a real-world display in the AR interface (block 5031) by displaying a first level of the information and by displaying a first level of the interactive options as well as displaying additional information of surroundings, such as alerts as to intervening objects that the user may want to avoid bumping into for safety, of the user and the location in the AR interface (block 5032). The displaying of the contextual information corresponding to the new contextual information granularity level of block 505 can include overlaying the appropriate contextual information on the real-world display in the AR interface (block 5051) by displaying a second level of the information, which differs from the first level, and displaying a second level of the interactive options, which differs from the first level, as well as displaying additional information of surroundings, such as alerts as to intervening objects that the user may want to avoid bumping into for safety, of the user and the location in the AR interface (block 5052).

That is, as a user begins to look at a location of the activity through AR goggles at a relatively far distance from the location of the activity, the contextual information granularity level may be relatively low. In this case, the contextual information can include information, such as a broad description of the activity, and interactive options, such as a set of basic interactive options like options for a lighting or a highlighting of the location of the activity. As the user continues to look at the location of the activity through the AR goggles but moves to a relatively short distance from the location of the activity, the contextual information granularity level may be relatively high. In this case, the contextual information can include information, such as the broad description of the activity, a narrow description of the activity and a description of additional information about the relationship between the activity and externalities, and interactive options, such as a set of basic, intermediate and advanced interactive options.

With reference to FIG. 6, an exemplary execution of the computer-implemented method 500 of FIG. 5 is illustrated. As shown in FIG. 6, a user has AR goggles 601 strapped to her face and is looking at a location 602 of an activity with which she is going to engage. The activity in this instance centers around an engine and could possibly relate to engine repair, though it is to be understood that this is merely an example and that the activity could be any type of activity. Concentric circles around the location 602 represent distances between the user and the location 602 with increasing location being illustrated as a circle with increased diameter. As shown in FIG. 6, when the user is furthest from the location 602 at the outermost circle, the contextual information granularity level is relatively low and the AR goggles 601 will overlay contextual information at a relatively low level of information (i.e., 20%) and no interactive options (i.e., 0%) on the real-world display of the location 602. As the user moves to the intermediate circle, the contextual information granularity level is at an intermediate level and the AR goggles 601 will overlay contextual information at an intermediate level of information (i.e., 50%) and some interactive options (i.e., 30%) on the real-world display of the location 602. As the user moves to the closest circle, the contextual information granularity level is at a relatively high level and the AR goggles 601 will overlay contextual information at a relatively high level of information (i.e., 100%) and all of the interactive options (i.e., 100%) on the real-world display of the location 602.

With continued reference to FIG. 6, the updating of the contextual information granularity level as the distance changes to obtain a new contextual information granularity level of block 504 can be executed discretely or in discrete steps as illustrated by the concentric circles of discrete distances from the location 602. In these or other cases, the updating occurs when the user reaches certain predefined distances from the location 602, where the predefined distances can be determined or calculated by the machine-learning algorithm. It is to be understood, however, that this is merely exemplary and that embodiments exist in which the updating is executed smoothly as distance between the user and the location 602 changes. In these or other cases, the AR goggles 601 will overlay smoothly changing contextual information over the real-world display of the location 602.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method for determining context granularity, the computer-implemented method comprising:
determining an activity for a user and a distance between the user and a location of the activity;
ascertaining a contextual information granularity level for displaying contextual information relevant to the activity in an augmented reality (AR) interface in accordance with the distance;
displaying the contextual information corresponding to the contextual information granularity level in the AR interface;
updating the contextual information granularity level as the distance changes to obtain a new contextual information granularity level; and
displaying the contextual information corresponding to the new contextual information granularity level in the AR interface.

2. The computer-implemented method according to claim 1, wherein the AR interface is supported by an article that is wearable by the user.

3. The computer-implemented method according to claim 1, wherein the ascertaining is executed by a machine-learning algorithm and is based on real-time updateable historic data of the user, the activity and surroundings.

4. The computer-implemented method according to claim 1, wherein the contextual information comprises information relevant to the activity and interactive options relevant to the activity for interaction with by the user.

5. The computer-implemented method according to claim 4, wherein:
the displaying of the contextual information corresponding to the contextual information granularity level comprises displaying a first level of the contextual information and displaying the first level of the interactive options, and
the displaying of the contextual information corresponding to the new contextual information granularity level comprises displaying a second level of the contextual information, which differs from the first level, and displaying the second level of the interactive options, which differs from the first level.

6. The computer-implemented method according to claim 1, wherein:
the displaying of the contextual information comprises overlaying the contextual information on a real-world display in the AR interface, and
the computer-implemented method further comprises displaying additional information of surroundings of the user and the location in the AR interface.

7. The computer-implemented method according to claim 1, wherein each instance of the updating is discrete.

8. A computer program product for determining context granularity, the computer program product comprising one or more computer readable storage media having computer readable program code collectively stored on the one or more computer readable storage media, the computer readable program code being executed by a processor of a computer system to cause the computer system to perform a method comprising:
determining an activity for a user and a distance between the user and a location of the activity;
ascertaining a contextual information granularity level for displaying contextual information relevant to the activity in an augmented reality (AR) interface in accordance with the distance;
displaying the contextual information corresponding to the contextual information granularity level in the AR interface;
updating the contextual information granularity level as the distance changes to obtain a new contextual information granularity level; and
displaying the contextual information corresponding to the new contextual information granularity level in the AR interface.

9. The computer program product according to claim 8, wherein the AR interface is supported by an article that is wearable by the user.

10. The computer program product according to claim 8, wherein the ascertaining is executed by a machine-learning algorithm and is based on real-time updateable historic data of the user, the activity and surroundings.

11. The computer program product according to claim 8, wherein the contextual information comprises information relevant to the activity and interactive options relevant to the activity for interaction with by the user.

12. The computer program product according to claim 11, wherein:
the displaying of the contextual information corresponding to the contextual information granularity level comprises displaying a first level of the contextual information and displaying the first level of the interactive options, and
the displaying of the contextual information corresponding to the new contextual information granularity level comprises displaying a second level of the contextual information, which differs from the first level, and displaying the second level of the interactive options, which differs from the first level.

13. The computer program product according to claim 8, wherein:
the displaying of the contextual information comprises overlaying the contextual information on a real-world display in the AR interface, and
the method further comprises displaying additional information of surroundings of the user and the location in the AR interface.

14. The computer program product according to claim 8, wherein each instance of the updating is discrete.

15. A computing system comprising:
a processor;
a memory coupled to the processor; and
one or more computer readable storage media coupled to the processor, the one or more computer readable storage media collectively containing instructions that are executed by the processor via the memory to implement cause the processor to perform steps comprising:
determining an activity for a user and a distance between the user and a location of the activity;
ascertaining a contextual information granularity level for displaying contextual information relevant to the activity in an augmented reality (AR) interface in accordance with the distance;
displaying the contextual information corresponding to the contextual information granularity level in the AR interface;
updating the contextual information granularity level as the distance changes to obtain a new contextual information granularity level; and
displaying the contextual information corresponding to the new contextual information granularity level in the AR interface.

16. The computing system according to claim 15, wherein the AR interface is supported by an article that is wearable by the user.

17. The computing system according to claim 15, wherein the ascertaining is executed by a machine-learning algorithm and is based on real-time updateable historic data of the user, the activity and surroundings.

18. The computing system according to claim 15, wherein:
the contextual information comprises information relevant to the activity and interactive options relevant to the activity for interaction with by the user,
the displaying of the contextual information corresponding to the contextual information granularity level comprises displaying a first level of the contextual information and displaying the first level of the interactive options, and
the displaying of the contextual information corresponding to the new contextual information granularity level comprises displaying a second level of the information, which differs from the first level, and displaying the second level of the contextual interactive options, which differs from the first level.

19. The computing system according to claim 15, wherein:
the displaying of the contextual information comprises overlaying the contextual information on a real-world display in the AR interface, and
the steps further comprise displaying additional information of surroundings of the user and the location in the AR interface.

20. The computing system according to claim 15, wherein each instance of the updating is discrete.
